(19) United States
(12) Patent Application Publication
(10) Pub. No.: US 2006/0112369 A1
(43) Pub. Date: May 25, 2006

(54) Method and system for capturing and checking computer system configuration information

(75) Inventors: You-Qing Yu, Shenzhen (CN); San-Yi Shu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/148,811

(22) Filed: Jun. 9, 2005

(30) Foreign Application Priority Data
Nov. 19, 2004 (TW) 93135573

(51) Int. Cl. G06F 9/44

(52) U.S. Cl. 717/100

(57) ABSTRACT

A method for capturing computer system configuration information of a computer includes the steps of: initializing a Component Object Model (COM) application programming interface of the computer; accessing a WMI (Windows Management Instrumentation) name space of the computer; creating objects for classes in the WMI name space; and capturing computer system configuration information on the computer from the objects. Another method for checking computer system configuration information on a client computer through a server computer includes the steps of: connecting the server computer with the client computer; capturing the client computers' computer system configuration information through each client computer's WMI; comparing the captured computer system configuration information with the predetermined computer system configuration information; and reporting the comparing result. A system for checking computer system configuration information is also disclosed.

### BACKGROUND OF THE INVENTION

1. Field of the Invention

The present invention relates to methods and systems for capturing and checking computer system configuration information, and particularly to a method and system for capturing and checking computer system configuration information through Windows Management Instrumentation (WMI).

2. Prior Art

The computer has become a permanent fixture in modern societies. Computers are used to facilitate data communications and electronic commerce between businesses, and to gather various types of data such as news, stock market quotes, research facts, sport scores, etc. Furthermore, computers serve as a source of entertainment through audio and/or visual output and/or display. Almost every aspect of one's daily life is affected by computers. More and more people have acquired or are going to acquire a personal computer (PC).

Users often prefer a unique system configuration for their individual PCs. In a build to order (BTO) and configure to order (CTO) computer ordering model, a customer orders PCs from a PC manufacturer, with the order specification detailing what particular computer system configuration the customer needs. An order specification describes predetermined system configuration information, which typically includes predetermined hardware configuration information, a predetermined operating system (OS), and predetermined application software that the customer wants installed on the ordered PCs. The PC manufacturer builds and configures the PCs accordingly. Once configuring of the ordered PCs is completed, the PC manufacturer usually captures each PC's current system configuration information, and checks whether such information accords with the predetermined system configuration information described in the order specification. Once the two sets of information are identical, the PC is ready to be shipped to the customer.

A traditional method for capturing computer hardware configuration information uses a software tool that captures a computer's hardware configuration information through the corresponding programming interfaces of the computer's hardware drives. This is done when the computer's OS is operating normally. However, in order to perform the method, data on the hardware drives and the software tool must be resident in the computer's memory.

The art of capturing a computer's hardware configuration information is disclosed in patent material such as China patent application No. 02128931.X published on Feb. 25, 2004 and entitled “Apparatus and method for capturing a computer's hardware configuration information.” The apparatus and method disclosed by the patent application can capture a computer's hardware configuration information regardless of whether the computer's OS is operating or not. The method can be performed even when the computer is powered off.

However, only hardware configuration information can be captured by the above methods. In some cases, the information on the OS and the application software installed on the computer is also required.

Accordingly, what is a need is a solution that can capture not only the hardware configuration information on a computer but also the information on the OS and the application software installed on the computer.

### SUMMARY

A preferred embodiment provides a method for capturing computer system configuration information of a computer supporting Windows Management Instrumentation (WMI). The method includes the steps of: initializing a Component Object Model (COM) application programming interface of the computer; accessing a WMI name space of the computer; creating objects for classes in the WMI name space; and capturing computer system configuration information on the computer from the objects.

In addition, a preferred method for checking computer system configuration information on a client computer through a server computer is provided. The client computer supports Windows Management Instrumentation (WMI). A database for storing predetermined computer system configuration information is coupled to the server computer. The method includes the steps of: connecting the server computer with the client computer; capturing the client computers' computer system configuration information through each client computer's WMI; comparing the captured computer system configuration information with the predetermined computer system configuration information; and reporting the comparison result.

Further, a preferred system for checking computer system configuration information is provided. The system includes a server computer, and a plurality of client computers. The client computers all support Windows Management Instrumentation (WMI). The system further includes a database for storing predetermined computer system configuration information. The server computer executes software for checking computer system configuration information. The software includes: a connecting module for connecting the server computer with each of the client computers; an information capturing module for capturing the client computers' computer system configuration information through each client computer's WMI; a comparing module for comparing the captured computer system configuration information with the predetermined computer system configuration information; and a reporting module for reporting the comparison results.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic diagram of hardware and software infrastructure of a system for checking computer system configuration information, in accordance with a preferred embodiment;

FIG. 2 is a schematic diagram of function modules of software for checking computer system configuration information, the software being part of the system of FIG. 1;

FIG. 3 is a flowchart of a preferred method for checking computer system configuration information; and

FIG. 4 is a flowchart of details of one step of FIG. 3, namely capturing the system configuration information of a client computer through WMI.

### DETAILED DESCRIPTION OF THE INVENTION

In a preferred embodiment of the present invention, a computer, such as a personal computer (PC), comprises various kinds of hardware devices. Further, the PC has had an operating system (OS) as well as some application software installed therein, the OS supporting Windows Management Instrumentation (WMI) such as Microsoft® Windows® 2000. WMI technology is an implementation of the Desktop Management Task Force's (DMTF's) Web-based Enterprise Management (WBEM) initiative for Microsoft® Windows® operating systems. WMI offers a powerful set of services, including query-based information retrieval and event notification. These services and the management data are accessed through a Component Object Model (COM) application programming interface. The WMI architecture comprises the following: a management infrastructure, including a Common Information Model Object Manager (CIMOM) and a CIMOM object repository; and WMI providers for the Win32 environment. Applications depend on the CIMOM to handle the interface between management applications and data providers. CIMOM facilitates these communications by providing a common programming interface, using COM, to the WMI. The WMI provides a name space including classes that represent WMI-managed objects, such as hardware devices, the OS, and application software. The name space includes 7 classes: WMI System Classes, WMI System Properties, Win32 Classes, CIM Classes, Standard Consumer Classes, MSFT Classes, MSMCA Classes, and WMI C++ Classes. The Win32 Classes further include Computer System Hardware Sub-classes, Operating System Sub-classes, Installed Applications Sub-classes, WMI Service Management Sub-classes, and Performance Counters Sub-classes. These sub-classes are well known by those skilled in the art, and further descriptions are not provided herein.

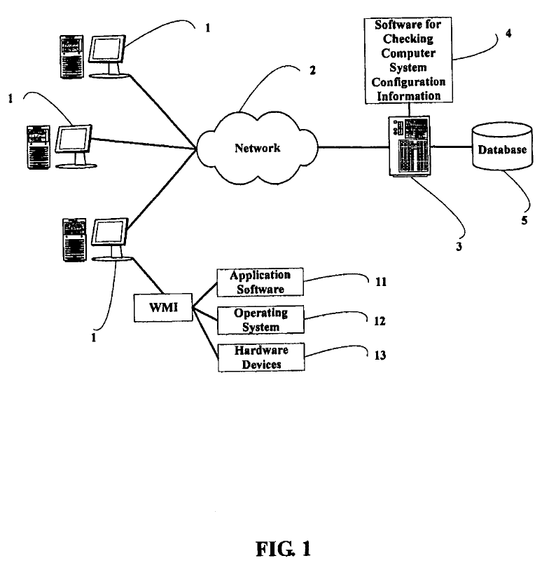

FIG. 1 is a schematic diagram of hardware and software infrastructure of a system for checking computer system configuration information (hereinafter, “the system”) in accordance with the preferred embodiment of the present invention. The system includes a plurality of client computers 1, and a server computer 3 executing software for checking computer system configuration information 4 (hereinafter, “the software 4”) through a network 2 such as the Internet. The system may also include a database 5 for storing predetermined computer system configuration information on the client computers 1. The software 4 captures computer system configuration information of each client computer 1 through a WMI of the client computer 1. The computer system configuration information typically includes information on hardware devices 13, and information on an OS 12 and application software 11 installed on the client computer 1. The software 4 then checks if the captured computer system configuration information accords with corresponding predetermined computer system configuration information on the client computer 1 stored in the database 5.

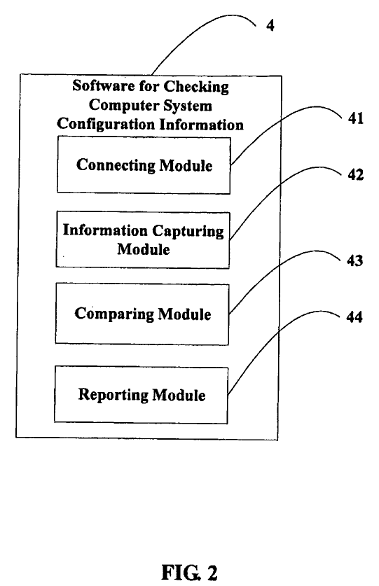

FIG. 2 is a schematic diagram of function modules of the software 4. The software 4 includes a connecting module 41 for connecting the server computer 3 with each of the client computers 1, an information capturing module 42 for capturing computer system configuration information of each of the client computers 1, a comparing module 43 for comparing the captured computer system configuration information with predetermined computer system configuration information stored in the database 5, and a reporting module 44 for reporting comparison results. The connecting module 41 can connect the server computer 3 with each of the client computers 1 through respective network interface cards of the client computers 1.

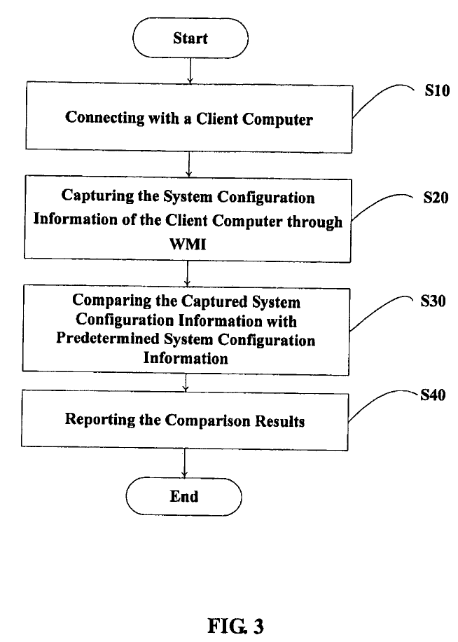

FIG. 3 is a flowchart of a preferred method for checking computer system configuration information of a client computer 1. In step S10, the connecting module 41 connects the server computer 3 with the client computer 1 through the network 2, to enable the server computer 3 to make requests for capturing the computer system configuration information of the client computer 1. In step S20, the information capturing module 42 captures the computer system configuration information from the client computer 1. In step S30, the comparing module 43 compares the captured computer system configuration information with corresponding predetermined computer system configuration information stored in the database 5, to check if they are identical. In step S40, the reporting module 44 reports comparison results to the server computer 3. The comparison results may be shown on a display screen coupled to the server computer 3.

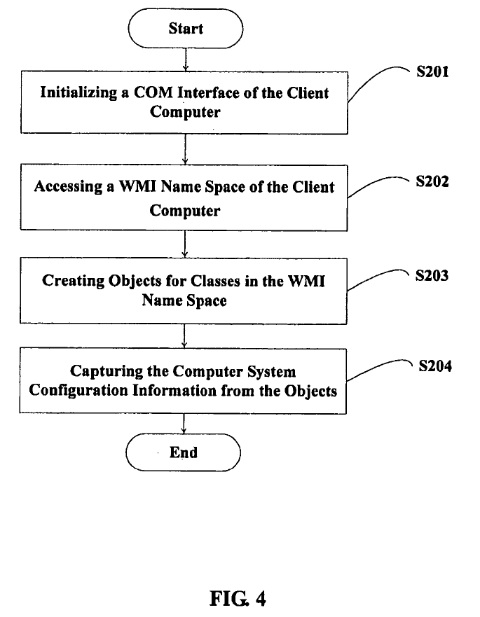

FIG. 4 is a flowchart of details of step S20 of FIG. 3, namely capturing the computer system configuration information of the client computer through WMI. In step S201, the information capturing module 42 initializes a COM application programming interface of the client computer 1, so that the software 4 is connected with the CIMOM of the client computer 1, in order to make requests for capturing the computer system configuration information. In step S202, the information capturing module 42 accesses a WMI name space to obtain sub-classes which represent the computer system configuration information. In step S203, the information capturing module 42 creates objects for the sub-classes accessed in step S202. The objects are evaluated with corresponding computer system configuration information provided by the WMI providers. In step S204, the information capturing module 42 captures the computer system configuration information from the objects.

In an alternative embodiment, the above-described method can be performed by a single computer. In such embodiment, the computer system captures configuration information of itself, and checks whether the captured computer system configuration information is identical with predetermined computer system configuration information.

Although the present invention has been specifically described on the basis of a preferred embodiment and preferred methods, the invention is not to be construed as being limited thereto. Various changes or modifications may be made to the embodiment and methods without departing from the scope and spirit of the invention.

We claim:

1. A method for capturing computer system configuration information of a computer supporting Windows Management Instrumentation (WMI), comprising the steps of: initializing a Component Object Model (COM) application programming interface of the computer;
accessing a WMI name space of the computer;
creating objects for classes in the WMI name space; and
capturing computer system configuration information on the computer from the objects.

2. The method according to claim 1, further comprising the step of comparing the captured computer system configuration information with predetermined computer system configuration information stored in a database.

3. The method according to claim 1, further comprising the step of reporting comparison results.

4. A method for checking computer system configuration information on a client computer through a server computer, in which the client computer supports Windows Management Instrumentation (WMI), the method comprising the steps of:
connecting the server computer with the client computer;
capturing the computer system configuration information through the WMI of the client computer;
comparing the captured computer system configuration information with predetermined computer system configuration information stored in a database; and
reporting comparison results.

5. The method according to claim 4, wherein the capturing step comprises the steps of: initializing a Component Object Model (COM) application programming interface of the client computer;
accessing a WMI name space of the client computer;
creating objects for classes in the WMI name space; and
capturing the computer system configuration information on the client computer from the objects.

6. A system for checking computer system configuration information, the system comprising a server computer, a plurality of client computers, and a database for storing predetermined computer system configuration information, each of the client computers supporting Windows Management Instrumentation (WMI), the server computer executing software for checking computer system configuration information on the client computers, the software comprising:
a connecting module for connecting the server computer with each of the client computers;
an information capturing module for capturing computer system configuration information of each of the client computers through the WMI of each of the client computers;
a comparing module for comparing the captured computer system configuration information with corresponding predetermined computer system configuration information; and
a reporting module for reporting comparison results.

7. The system according to claim 6, wherein the connecting module connects the server computer with each of the client computers through respective network interface cards of the client computers.
